(19) United States
(12) Patent Application Publication
(10) Pub. No.: US 2015/0334440 A1
(43) Pub. Date: Nov. 19, 2015

(54) SMART AUDIOVISUAL INTEGRATION DEVICE

(71) Applicant: Wen-Sung Lee, Taichung City (TW)

(72) Inventor: Wen-Sung Lee, Taichung City (TW)

(21) Appl. No.: 14/280,692

(22) Filed: May 19, 2014

(51) Int. Cl. H04N 21/41; H04L 12/28

(52) U.S. Cl. CPC H04N 21/4131; H04L 12/2805

(57) ABSTRACT

A smart audiovisual integration device of this invention is disclosed which includes an audiovisual apparatus; a master controller, connected to the audiovisual apparatus in a wireless connection, where the master controller comprises an inventory unit, a zone unit and a setting unit. The inventory unit is provided with a selection of plural play modes corresponding to the desired audiovisual targets to enjoy, and the zone unit is provided with a choice of plural zones corresponding to the desire sections of a residence to stay. The setting unit is provided with detailed settings for the audiovisual apparatus according to the audiovisual targets. Once a desired section of the residence is selected and a desired audiovisual target is selected further, the audiovisual apparatus is adjusted automatically to the detailed setting of the corresponding mode through the control of the master controller, which cuts down the time for the self-adjustment by the user.

### BACKGROUND OF THE INVENTION

1. Field of the Invention

The present invention relates to smart audiovisual integration devices, and more particularly relates to one that is capable of integrating the whole audiovisual equipment and featuring adaptive adjustment of the whole audiovisual equipment to a desired play mode in accordance with the audiovisual target of the user.

2. Description of Related Art

Home appliances were not popular back to the 30's and 60's. Home appliances like black and white televisions, washers or radio sets are for sure the most pervasive at those times, which all call for manual adjustment by the user, for the purposes of activation and selection. However, with the advancement of times and in this new era of technology explosion, numerous household products march towards featuring smart. By means of specific electronic devices, for instance, cell phones, tablets and the like, and through the use of specific telecommunication setup, the user away from home is able to control the household products, like refrigerators, televisions, microwave ovens, etc to operate. For instance, a scenario that washed rice is already placed in an electric oven and ready for cooking before going to work. The power to the electric oven is activated to cook the rice by means of a cell phone later afternoon on the way home. A similar example like opening air conditioner to cool room temperature by means of the control by a cell phone on the way home, which substantially cuts down the time to wait.

Conventional smart home appliances appear in various outlooks, for instance, a prior exemplified smart product comprises a remote communication unit and an integration unit, where the integration unit is connected in between an information center of the housing office and an audiovisual play unit of the household end, which enables the audiovisual play unit simultaneously to receive internal household information from the information center during the receiving of external digital or analog signals, and to display a mealtime screen at the audiovisual play unit, by which users provide the control through the remote communication unit. And the remote communication unit also can be utilized to directly communicate with the housing office, to achieve the integration of the housing with information.

The above example is a popular control scheme for the advancement of the technology nowadays, where the user is able to control the operation of different home appliances by means of the setup of the integration unit and the use of the remote communication unit. However, various home appliances have different features based on different operational modes. For instance, as stereo oriented audiovisual equipment is concerned, the sound effect will be different subject to different programs watched by the user. Once the user watches a symphony program, the sound effect is adjusted in accordance with the symphony; on watching a movie, the sound effect is switched to the movie mode. Moreover, a succeeding viewer often changes the mode for sound effect relative to the preceding viewer to suit her/his own needs, which consumes time for such adjustments. On the other hand, the adjustment of audiovisual equipment calls for field professional of that specific techniques, instead of general users. The false adjustment could bring about tough restoration. And the complexity of the audiovisual equipment leads to time consuming for the adjustment by general users. Therefore, the relating manufacturers nowadays have to think over the convenience for the adjustment by different level of users.

In view of the drawbacks of the aforementioned examples, this inventor conceived deeply the idea to the research of the invention, the comparison of each advantage and disadvantage with the prior art, and the development of the relating products, and eventually the longtime endeavors gave birth to “Smart Audiovisual Integration device” of this invention, which improves the aforementioned drawbacks, to suit the use by general users.

### SUMMARY OF THE INVENTION

The primary objective of the present invention is to provide an optimal play mode based on the selected program of a succeeding user and is free of further adjustment of the audiovisual equipment, which avoids the waste of time due to the false self-adjustment, to improve the drawbacks of the prior techniques; that is, the prior art fails to provide an optimal play mode subject to the selected program by the different users. The prior techniques require self-adjustment for the connecting lines, play mode and the like of the audiovisual equipment, which are easy to lead to problems of false adjustment, mode lost or damage to the apparatus.

Accordingly, the present invention attempts to improve the foregoing shortcomings to achieve the aforementioned objective and function. The present invention, a smart audiovisual integration device, is used to control plural home appliances at every section of a residence, comprising: an audiovisual apparatus; a master controller, connected to the audiovisual apparatus in a wireless connection, where the master controller comprises an inventory unit, a zone unit and a setting unit. The inventory unit is provided with a selection of plural play modes corresponding to the desired audiovisual targets to enjoy, and the zone unit is provided with a choice of plural zones corresponding to the desire sections of a residence to stay. The setting unit is provided with detailed settings for the audiovisual apparatus according to the audiovisual targets. Once a desired section of the residence is selected and a desired audiovisual target is selected further, the audiovisual apparatus is adjusted automatically to the detailed setting of the corresponding mode through the control of the master controller, which cuts down the time for the self-adjustment by the user.

A further technical feature of the present invention is that the master controller further comprises a manual adjustment setting unit, where the manual adjustment setting unit offers the user an adjustment of the detailed setting of the audiovisual apparatus according to the audiovisual target.

A further technical feature of the present invention is that the inventory unit is provided with a selection of play modes as follows: movie mode, television mode, song mode, slumber mode, video mode and home theater mode.

A further technical feature of the present invention is that the master controller is a tablet computer or a smart phone, and the audiovisual apparatus is embodied as a television, a karaoke, an amplifier, a home theater, a DVD player and a stereo system.

A further technical feature of the present invention is that the master controller is provided with a timing setting unit, where the timing setting unit is used to set the time for the audiovisual apparatus to operate.

A further technical feature of the present invention is that the master controller is provided with a reminding unit, where the reminding unit is used to remind the user the change of original settings of the setting unit according to the changing of the play mode by the user.

A further technical feature of the present invention is that the master controller is provided with an on-off unit, where the on-off unit is used to control the ON and OFF of the audiovisual apparatus.

To summarize the aforementioned technical features of this invention, the advantage lies in the making use of the various built-in units of the master controller. Once desiring to watch a movie, simply to select a corresponding movie mode, and the master controller will control each of the audiovisual apparatus to adjust automatically to the movie mode. Once for music, a song mode is selected, and each of the audiovisual apparatus is adjusted automatically to the song mode. Accordingly, this design approach enables the user to save much more time in selection, manipulation and alteration, which avoids the self-adjustment of the setting of the audiovisual apparatus relative to the preceding user, substantially diminishing the waste of time and energy, and further avoiding the influence of the operation of the audiovisual apparatus by false adjustment. Therefore, this invention is a creation of practicality and inventiveness, considerably worthy of promotion by the industry, and open to the public.

### BRIEF DESCRIPTION OF THE DRAWINGS

FIG. 1 is a schematic block diagram of a preferred embodiment of the present invention;

FIG. 2 is a schematic diagram in a bedroom A where the user selects television mode by the master controller, and controls the related audiovisual apparatus for the adaptive adjustment of a preferred embodiment of the present invention;

FIG. 3 is a schematic diagram in a parlor where the user selects movie mode by the master controller, and controls the related audiovisual apparatus for the adaptive adjustment of a preferred embodiment of the present invention; and

FIG. 4 is a schematic diagram in a bedroom B where the user selects sleeping mode by the master controller, and controls the related audiovisual apparatus for the adaptive adjustment of a preferred embodiment of the present invention.

### DETAILED DESCRIPTION OF THE INVENTION

To describe clearly that the present invention is able to achieve the foregoing objective and function, which relates to a smart audiovisual integration device, where its adopted techniques, means and the desired function are described as follows with reference to a preferred embodiment and accompanying drawings.

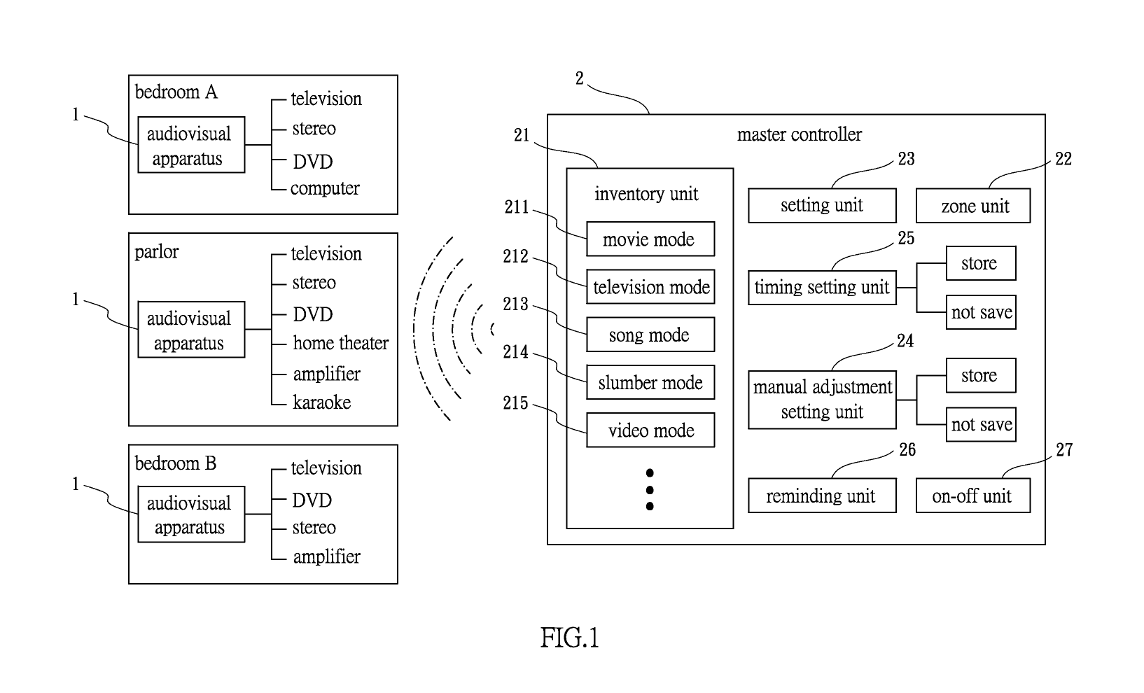

Some preferred embodiments are described in the following, which are not intended to limit the scope of this invention. With reference to FIGS. 1-4, the present invention, a smart audiovisual integration device, aims to control plural home appliances in various sections of a residence, comprising: an audiovisual apparatus 1, offering users enjoyment in vision and hearing; a master controller 2, connected to the audiovisual apparatus 1 wirelessly, where the master controller 2 controls the various adjustments of the audiovisual apparatus 1, and comprises an inventory unit 21, a zone unit 22 and a setting unit 23. The inventory unit 21 is provided with a selection of plural play modes corresponding to the desired audiovisual targets to enjoy, and the zone unit 22 is provided with a choice of plural zones corresponding to the sections of the residence to stay. The setting unit 23 is provided with detailed settings for the audiovisual apparatus 1 according to the audiovisual target. Once a desired zone is selected from the zone unit 22 and a play mode for the desired audiovisual target is selected, the audiovisual apparatus 1 is automatically adjusted to the detailed settings of the corresponding play mode through the control by the master controller, which cuts down the time for the self-adjustment.

First of all, a grasp of the selection of play modes in the inventory unit 21 of the present invention is given here, where the selection comprises the following modes: movie mode 211, television mode 212, song mode 213, slumber mode 214, video mode 215 and home theater mode. The master controller 2 manipulated by the user is a tablet computer or a smart phone, which is electrically connected to the audiovisual apparatus 1 in a wireless or wired connection. And the audiovisual apparatus 1 controlled by the master controller 2 is embodied as a television, a karaoke-on-demand, an amplifier, a home theater, a DVD player or a stereo system (the aforesaid selection of the inventory unit 21, the types of the master controller 2 and the embodiments of the audiovisual apparatus 1 are not intended to be limited by the above description), shown in FIG. 1.

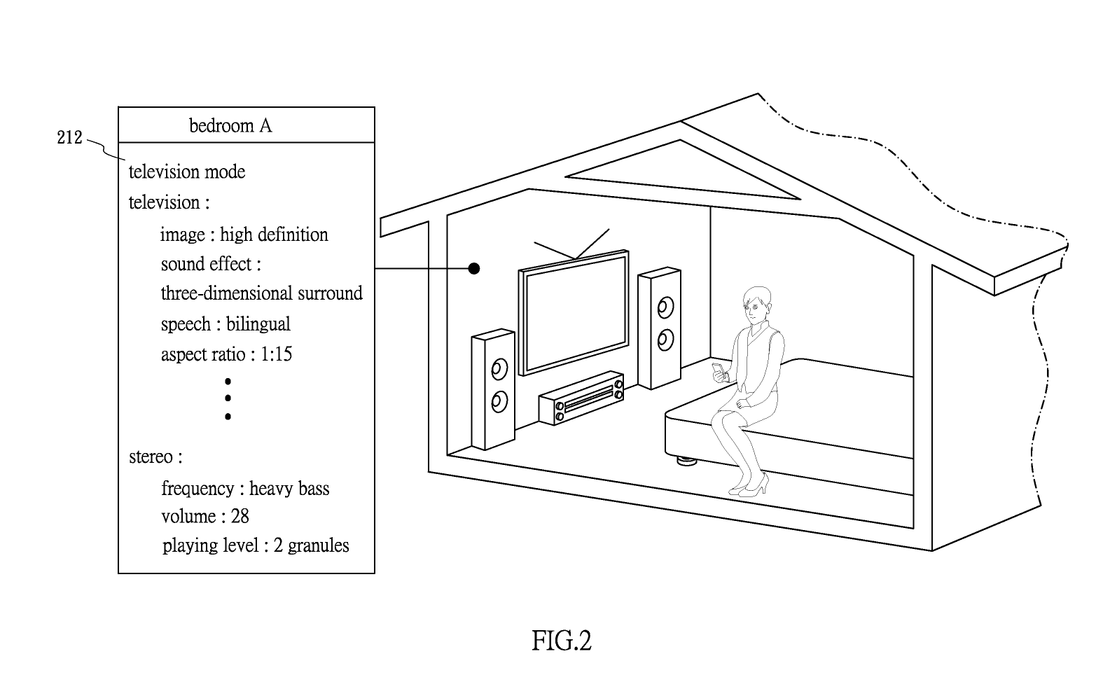

According to the foregoing description, actual examples are enumerated for illustration; for instance, shown in FIG. 2, with a reference to FIG. 1. Once a user intends to watch audiovisual apparatus 1 in a bedroom A, the audiovisual equipment to be employed involves a television and a stereo; therefore, the user selects television mode 212 item from the inventory unit 21 through the use of the master controller 2, and selects a zone from the zone unit 22 item, with which the original detailed settings of the television and the stereo at the bedroom A by the setting unit 23 can be adjusted. Supposing the television and stereo are the required audiovisual apparatus for watching television at the bedroom A which are originally set by the setting unit 23 by means of the master controller 2, where the detailed settings of the television are as follows: image—high definition, sound effect—three-dimensional surround, speech—bilingual, aspect ratio—1:15, etc, and the detailed settings of the stereo are as follows: frequency—heavy bass, volume—28, playing level —2 granules, etc. When the user intends to watch television at the bedroom A next time, whatever she/he needs is to select the same mode which controls the television and the stereo to automatically switch to the original settings, substantially reducing the adjusting time by the user, which avoids mode lost or damage to the apparatus by the self-adjustment.

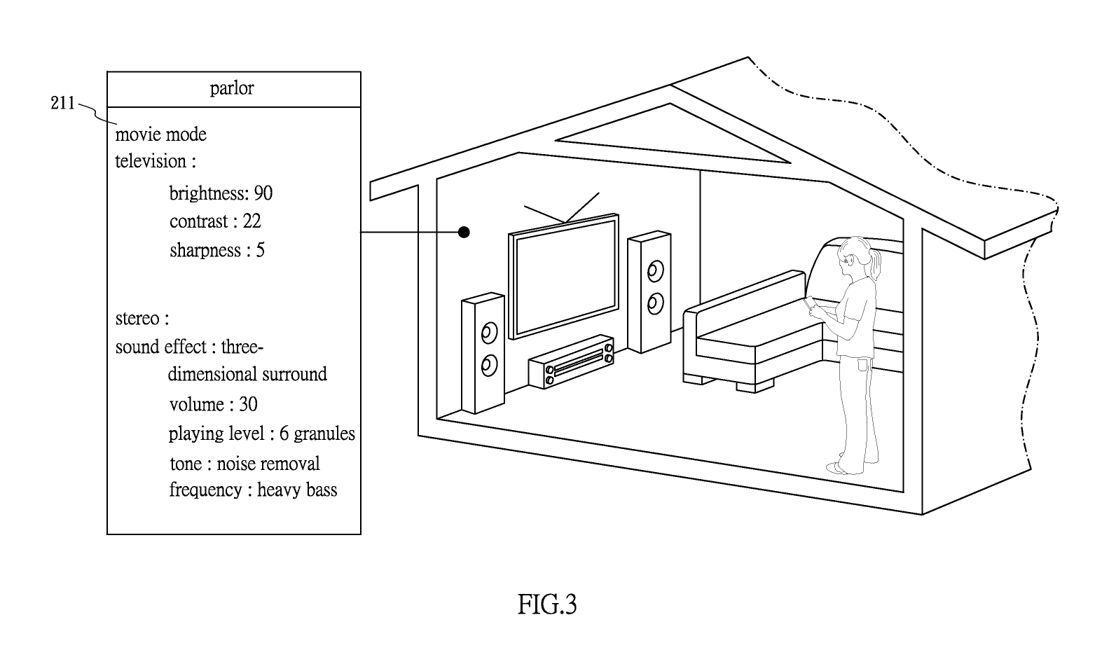

Another example is provided herein for illustration, shown in FIG. 3, with a reference to FIG. 1. Once a user intends to watch a movie in the parlor, the user simply selects the corresponding movie mode 211 and the desired zone of the zone unit 22 by means of the master controller 2, and the master controller 2 proceeds to the control of the adjustment of the audiovisual apparatus 1 such as television, stereo, player, home theater and the like automatically. However, the detailed settings to control the audiovisual apparatus 1 demanded by the movie mode 211 for watching movie has to be set first by the setting unit 23. For instance, the stereo is set according to the user preference as follows: sound effect—three-dimensional surround, volume—30, tone—noise removal, and frequency—heavy bass; the television settings as follows: brightness—90, contrast—22, sharpness—5; and the player settings: section—3^{rd}, playing sequence—cyclic. By means of the original setting of the movie mode 211 in the setting unit 23, once the user intends to watch a movie in the parlor, she/he simply controls the automatic adjustment of the relating audiovisual apparatus 1 by selecting the movie mode 211 from the inventory unit 21 of the master controller 2, which enables the user the adjustment of all the relating audiovisual apparatus 1 to the optimal watching simply sitting on the chair.

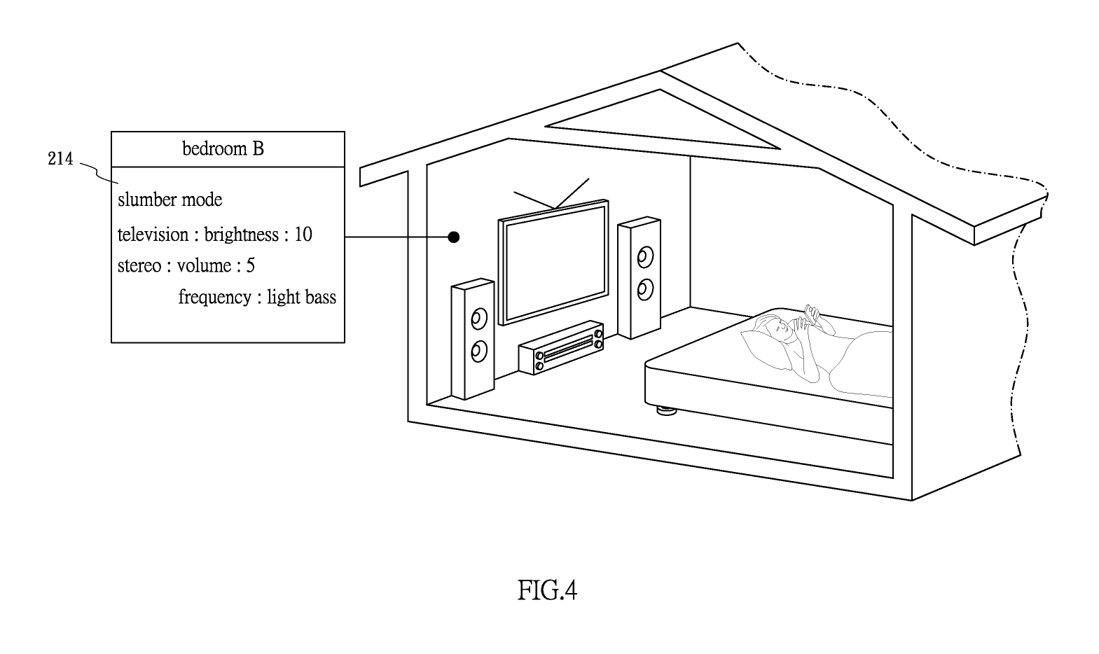

Aside from the setting of various audiovisual modes by the setting unit 23 of the present invention, the user is available to adjust the detailed settings of each mode according to the circumstances at that time and the personal preference, shown in FIG. 1. Therefore, a manual adjustment setting unit 24 is built in the master controller 2, and the user is able to adjust the detailed settings of various modes with the setup of the manual adjustment setting unit 24, with which the optimal audiovisual target can be tuned. Moreover, the user is asked whether to save the adjusted detailed settings or not after the manual adjustment of the original detailed settings is done, with which the optimal audiovisual effect of each mode can be accomplished. Besides, the master controller 2 is further provided with a timing setting unit 25, where the timing setting unit 25 is used to set the time for the audiovisual apparatus 1 to operate through the user. Please refer to FIG. 4. For instance, the master controller 2 is used to select the slumber mode 214 in the bedroom B, and the timing setting unit 25 is used to set the audiovisual apparatus 1 to operate for 30 minutes. With above settings, the audiovisual apparatus 1 will be automatically shut down after 30 minutes to cut down the consuming of electrical power. Once a user is ready to sleep in the bedroom B, the operational time of the relating audiovisual apparatus 1 may be first set through the timing setting unit 25, and the slumber mode 214 is selected from the inventory unit 21 for the following controls: television brightness—10, stereo volume—5, frequency—light bass, time to operate—shut down after 30 minutes automatically. In this way, the user can be easy to sleep, no need to worry about the waste of electric power and the increasing charge. The timing setting unit 25 further allows the set time to be saved. With the assistance by the manual adjustment setting unit 24 and the timing setting unit 25, the user enjoys the high level of delight brought by the audiovisual equipment.

Once detailed settings of respective modes are set by the setting unit 23, operating time is set by the timing setting unit 25, and the detailed adjustment are done by the manual adjustment setting unit 24, the master controller 2 is further provided with a reminding unit 26, to remind the user whether or not to save the modified settings. The reminding unit 26 offers the user the reminding during the alteration of the setting and the saving of the settings, where the original detailed settings can be employed without the need to adjust by the user. The master controller 2 is further provided with an on-off unit 27, where the on-off unit 27 is used to control the ON and OFF of the audiovisual apparatus 1 by means of the master controller 2, shown in FIG. 1.

According to the foregoing illustration in accordance with the present invention, and the provision of the built-in units of the master controller 2, the user is available to control the operation of respective audiovisual apparatus 1 at each section of her/his residence by means of the master controller 2, substantially reducing the time for the adjustment of every audiovisual apparatus 1 by the user. The desired play modes at different audiovisual apparatus are different, the adjustment of audiovisual apparatus calls for field professional of that specific techniques, instead of general users. Therefore, the master controller 2 is able to offer the general users an easy way to directly select a corresponding mode according to the desired audiovisual target, such as watching movie, watching television, listening to orchestra and the like. The master controller 2 is used to control the automatic detailed adjustments of the relating audiovisual apparatus 1 according to the desired audiovisual target, which reduces the damage coursed by self-adjustment of the relating audiovisual apparatus 1. The inventory unit 21 is able to set adequate modes to save according to different accustoms of the users. For instance, the movie mode 211 is categorized into A, B, and C branches (A, B and C are the detailed items of the movie mode 211, for example, valley echo mode, concert hall mode, loud speak mode, which provide users a further detailed selection). And different categories of the movie mode 211 are subject to different accustoms of the users, with which more users are able to control the operation of respective audiovisual apparatus 1 by means of the master controller 2, and more to use the corresponding play modes. This invention features great practicality by comparing with the prior techniques, and conforms to the demands of general public.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

In conclusion, the practicality and cost benefit of the present invention “Smart Elevator Control Device” are completely compliant to the requirements of industry development, and the disclosed structure of the invention had not appeared in the prior art, which is no doubt to possess novelty, and this invention features efficacy better than the prior structure which is construed to be a creative invention, thereby filing the present application herein subject to the patent law, which may obtain a patent thereof.

What is claimed is:

1. A smart audiovisual integration device, to control a plurality of home appliances at each section of a residence, comprising:
an audiovisual apparatus; and
a master controller, connected to said audiovisual apparatus wirelessly, where said master controller comprises an inventory unit, a zone unit and a setting unit, and the inventory unit being provided with a selection of a plurality of play modes corresponding to audiovisual targets, the zone unit being provided with a choice of a plurality of zones corresponding to sections of a residence while the setting unit is provided with detailed settings for said audiovisual apparatus according to the audiovisual targets, wherein a desired section of the residence is selected and a desired audiovisual target is selected further, said audiovisual apparatus being adjusted automatically to the detailed settings of a corresponding play mode through control of said master controller, which cuts down the time for the self-adjustment by a user.

2. The smart audiovisual integration device as claimed in claim 1, wherein said master controller further comprises a manual adjustment setting unit, where the manual adjustment setting unit offers the user an adjustment of detailed setting of said audiovisual apparatus according to the audiovisual target.

3. The smart audiovisual integration device as claimed in claim 1, wherein the inventory unit is provided with a selection of play modes as follows: movie mode, television mode, song mode, slumber mode, video mode and home theater mode.

4. The smart audiovisual integration device as claimed in claim 1, wherein said master controller is a tablet computer or a smart phone, and said audiovisual apparatus is embodied as a television, a karaoke, an amplifier, a home theater, a DVD player and a stereo system.

5. The smart audiovisual integration device as claimed in claim 1, wherein said master controller is provided with a timing setting unit, where the timing setting unit is used to set the time for said audiovisual apparatus to operate.

6. The smart audiovisual integration device as claimed in claim 1, wherein said master controller is provided with a reminding unit, where the reminding unit is used to remind the user a change of original settings of the setting unit according to a change to a play mode by the user.

7. The smart audiovisual integration device as claimed in claim 1, wherein said master controller is provided with an on-off unit, where the on-off unit is used to control the ON and OFF of said audiovisual apparatus.
